(19) United States
(12) Patent Application Publication
(10) Pub. No.: US 2026/0269906 A1
(43) Pub. Date: Sep. 10, 2026

(54) UCI OMISSION FOR TYPE II CODEBOOK TO SUPPORT MULTI-TRP COHERENT JOINT TRANSMISSION

(71) Applicant: APPLE INC., Cupertino, CA (US)

(72) Inventors: Haitong Sun, Cupertino, CA (US); Dawei Zhang, Saratoga, CA (US); Dan Wu, Beijing (CN); Wei Zeng, San Diego, CA (US); Chunxuan Ye, San Diego, CA (US)

(21) Appl. No.: 19/166,334

(22) PCT Filed: Apr. 5, 2023
(86) PCT No.: PCT/CN2023/086359

§ 371 Date: Sep. 17, 2025

(51) Int. Cl. H04B 7/06; H04L 5/00

(52) U.S. Cl. CPC H04B 7/0626; H04L 5/0044

(57) ABSTRACT

Apparatus and methods are provided for uplink control information (UCI) omission. A user equipment (UE) in a wireless network receives signals from a plurality of transmission and reception points (TRPs) and determines, based on the signals, uplink control information (UCI) for multiple TRP (mTRP) coherent joint transmission (CJT) channel state information (CSI) feedback using a codebook W=W₁*W₂*W_{f} for a spatial basis selection matrix W₁, a combination coefficient matrix W₂, and a frequency basis selection matrix W_{f}. The UE divides linear combination coefficient information into a first group and a second group based on respective priorities associated with linear combination coefficients in the combination coefficient matrix W₂. The UE transmits a reduced-size CSI report comprising the linear combination coefficient information in the first group and omitting at least a portion of the linear combination coefficient information in the second group.

### TECHNICAL FIELD

This application relates generally to wireless communication systems, including uplink control information (UCI) omission.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a PMI matrix (codebook) used in certain embodiments herein.

FIG. 2 illustrates multi-TRP operation that may be used according to certain embodiments disclosed herein.

FIG. 3 illustrates a flowchart of a method of a UE for communication in a wireless network according to certain embodiments disclosed herein.

FIG. 4 illustrates a flowchart of a method of a wireless network according to certain embodiments disclosed herein.

FIG. 5 illustrates a flowchart of a method of a UE for communication in a wireless network, according to certain embodiments disclosed herein.

FIG. 6 illustrates a flowchart of a method of a wireless network, according to certain embodiments disclosed herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, a reference signals (RS) may be provided to deliver a reference point for downlink power. When a wireless communication device or mobile device (i.e., UE) attempts to determine downlink power (e.g., the power of the signal from a base station, such as eNB for LTE and gNB for NR), it measures the power of the reference signal and uses it to determine the downlink cell power. The reference signal also assists the receiver in demodulating the received signals. Since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation) to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver (e.g., UE) receiving the transmitted signal(s).

The feedback information is used in selecting a precoding matrix candidate by defining the same codebook at both the transmitter and the receiver, and using the feedback information from the receiver as an indication of a preferred precoding matrix. In such cases the feedback information includes what is referred to as a precoding matrix index (PMI), which can be based on properties of the signals received at the receiver. For example, the receiver may determine that a received signal has relatively low signal-to-noise ratio (SNR), and may accordingly transmit a PMI that would replace a current precoding matrix with a new precoding matrix to increase the signal-to-noise ratio (SNR).

In 3GPP NR systems, two types of codebook, Type I codebook and Type II codebook, have been standardized for CSI feedback in support of advanced MIMO operations. The two types of codebook are constructed from a two-dimensional (2D) discrete Fourier transform (DFT) based grid of beams, enabling CSI feedback of beam selection and phase shift keying (PSK) based co-phase combining between two polarizations. Type II codebook based CSI feedback also reports the wideband and subband amplitude information of the selected beams, allowing for more accurate CSI to be obtained. This, in turn, provides improved precoded MIMO transmissions over the network.

Under certain circumstances, the set of precoding matrix candidates that can be selected from the codebook may need to be limited. For example, the network may prevent the receiver from selecting some precoding matrix candidates while allowing it to select others. This is commonly referred to as codebook subset restriction (CBSR). CBSR may include the transmission of a CBSR bitmap from a transmitter (e.g., base station) to a receiver (e.g., UE). The CBSR bitmap typically includes a bit corresponding to each precoding matrix in the codebook, with the value of each bit (e.g., “0” or “1”) indicating to the receiver whether or not the receiver is restricted from considering a corresponding precoding matrix candidate as a preferred precoding candidate to request from the base station. One disadvantage of CBSR is increased signaling overhead. For example, in some systems, the CBSR bitmap might contain a high number (e.g. 64) of bits per channel, requiring a transmitting device to transmit a relatively large amount of information to implement CBSR for all of its channels.

For multi-user multiple-in multiple-out (MIMO) systems, a base station may configure multiple UEs (e.g. two UEs) to report their precoding matrices, or precoding matrix candidates in mutually orthogonal directions. To reduce the CSI computation complexity for the UE, a base station may remove from consideration, based on uplink measurements, certain unlikely beams, thereby allowing the UE to not test the precoders formed by those beams that were removed from consideration. In other words, in order to reduce computation complexity, based on UL measurements the base station can restrict the UE to narrow the search space. Thus, the UE does not have to consider the entire codebook.

For 3GPP Release-15 (Rel-15) Type II port selection codebook, a beam-formed channel state information reference signal (CSI-RS) exploits downlink (DL) and uplink (UL) channel reciprocity. For example, the base station estimates the UL channel and, based on channel reciprocity, acquires the channel state information regarding the DL channel. Then, based on the DL channel information, the base station precodes different ports in CSI-RS differently for the UE to perform further CSI reporting for CSI refinement. The UE measures CSI-RS and provides feedback to the base station. For a total number X of CSI-RS ports, X/2 ports are horizontally polarized (H-pol) and X/2 ports are vertically polarized (V-pol). L CSI-RS ports are selected out of X/2 CSI-RS ports. The first CSI-RS port may be selected every d ports (e.g., d is either 1 or 2 or 3 or 4). Then, consecutive L (e.g., 1, 2, 4) ports are selected with wrap around.

3GPP Rel-16 Type II port selection codebook enhancement uses the same port selection design as 3GPP Rel-15. When subband PMI is configured, a frequency domain DFT matrix can be used to compress the linear combination coefficients.

For Type II port selection codebook, it may be assumed that the base station will precode the CSI-RS based on channel reciprocity (i.e., DL channel estimated based on UL channel). For frequency division duplexing (FDD), exact channel reciprocity may not exist, especially when the duplexing distance is large. However, even for FDD, partial reciprocity may still exist when, for example, the angle of arrival or departure is similar between DL and UL carriers and/or the channel delay profile is similar between DL and UL carriers.

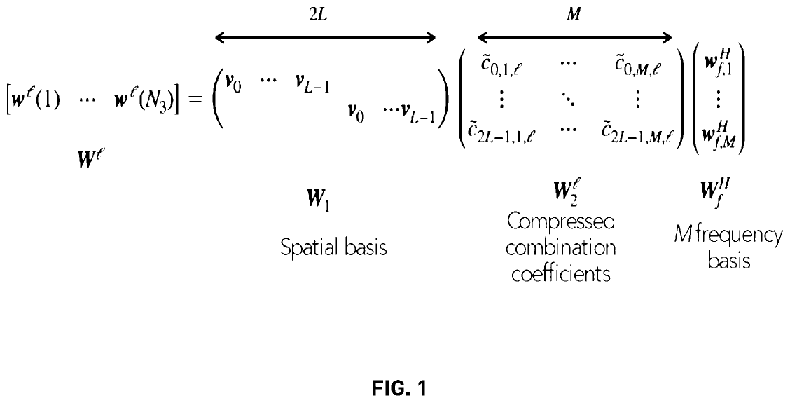

FIG. 1 illustrates a PMI matrix (codebook) used in certain embodiments herein. In the illustrated example, a Type II codebook structure is given by

$${W}^{ℓ} = {W}_{1} * {W}_{2}^{ℓ} * {W}_{f}^{H}$$

(also notated for simplicity herein as W=W₁*W₂*W_{f} or W=W1W2Wf), where W is the PMI matrix (also referred to herein simply as codebook), W₁ is a spatial basis selection matrix (also referred to herein as a port selection matrix W₁), W₂ provides compressed combination coefficients, W_{f} is a frequency basis selection matrix, l is a layer index, N₃ is the number of PMI subbands in frequency (i.e., the length or number of entries in each frequency base), L is the number of selected spatial basis (i.e., number of selected ports), M is the number of selected frequency basis, and H denotes a Hermitian matrix or conjugate transpose operation. For simplicity, “W_{f}” or “W_{f}” assumes that the Hermitian operation has already been performed. These and other parameters of

$${W}^{ℓ} = {W}_{1} * {W}_{2}^{ℓ} * {W}_{f}^{H}$$

are shown in other figures and/or described in detail below.

In certain systems, for codebook enhancements utilizing DL/UL reciprocity of angle and/or delay, support is provided for codebook structure W=W₁*W₂*W_{f} where the matrix W₁ is a free selection matrix, with the identity matrix as a special configuration. The frequency basis selection matrix W_{f} is a DFT based compression matrix in which N₃=N_{CQISubband}*R and Mv>=1, where R is a size of the channel quality indicator (CQI) subband divided by the size of the PMI subband, and Mv is the number of selected frequency basis. N₃ is the number of PMI subbands for frequency basis selection. At least one value of Mv>1 may be supported. In certain such systems, value(s) of Mv may be decided (e.g., Mv=2). In other embodiments, support of Mv>1 is a UE optional feature, taking into account UE complexity related to codebook parameters. However, candidate value(s) of R, mechanisms for configuring/indicating to the UE and/or mechanisms for selecting/reporting by UE for W_{f} have yet to be determined. In addition, or in other systems, W_{f} can be turned off by the base station. When turned off, W_{f} may be an all-one vector.

In Rel-15, Type II and Type II codebook is specified based on W₁*W₂. In Rel-16, enhanced Type II and Type II codebook is specified based on W₁*W₂*W_{f}.

In Rel-17, further enhanced Type II codebook is specified. For example, CSI feedback in Rel-17 is further enhanced for non-coherent joint transmission (NCJT) for multiple transmission and reception point (TRP) operation (referred to as multi-TRP or mTRP). In certain wireless networks, NCJTs may be used to provide multiple-input multiple-output (MIMO), multiple-user (MU) MIMO, and/or coordinated multi-point (CoMP) communications. The NCJTs may be from multi-TRP, multiple panels (multi-panels) of a TRP, or a combination thereof. Coherent joint transmission (CJT) uses synchronization among TRPs. However, for distributed TRPs, the precoders may not be jointly designed and such that the TRPs are not synchronized. Instead, each TRP derives the precoder independently without knowledge of the precoders used by the other TRPs. Thus, the joint transmission is non-coherent. In Rel-17, CSI feedback for NCJT for multi-TRPs is based on Type I MIMO codebook, which only supports single downlink control information (DCI) multi-TRP NCJT scheme 1a (i.e., spatial domain multiplexing (SDM)).

In certain communication systems (e.g., Rel-18 NR), it may be desirable to provide CSI enhancement to support CJT for multi-TRP. CJT assumes that multiple TRPs can jointly precode the transmission in a coherent way. Certain such systems may, for example, target frequency range 1 (FR1) and up to four TRPs, assuming an ideal backhaul and synchronization as well as the same number of antenna ports across TRPs, as follows: Rel-16/17 Type II codebook refinement for CJT mTRP targeting FDD and its associated CSI reporting, taking into account throughput-overhead tradeoff. However, embodiments disclosed herein are not so limited (fewer than four or more than four TRPs may be used).

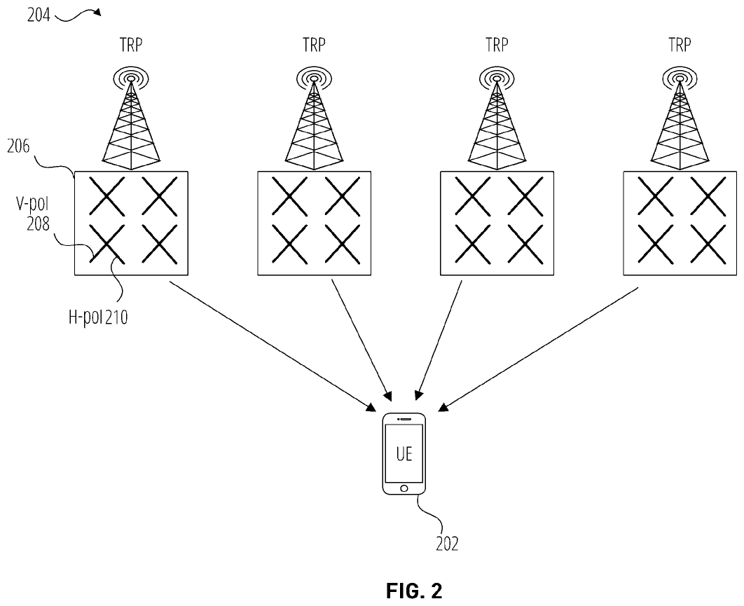

For example, FIG. 2 illustrates multi-TRP operation that may be used according to certain embodiments disclosed herein. A UE 202 receives signals from four TRPs 204. Each TRP includes an antenna panel 206 that has eight ports (i.e., antenna elements), wherein four of the ports are V-pol and four of the ports are H-pol. For example, a cross-polarized antenna may include a V-pol port 208 and an H-pol port 210. Thus, the four TRPs 204 use a combined total of 32 ports.

In certain embodiments, for multi-TRP CJT, the UE 202 may use two codebook structures in a first mode (Mode 1) and a second mode (Mode 2). Mode 1 provides independent frequency basis selection for different TRPs or different TRP groups (i.e., W_{f,n},n=1, 2, . . . , N, where N is the number of TRPs or TRP groups), which corresponds to a more general codebook structure to handle non-collocated TRPs. For example, in Mode 1, the codebook to allow independent frequency domain basis selection across N TRPs or TRP groups may be given by

$$W = [ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

Mode 2 provides common frequency basis selection among all TRPs or TRP groups (i.e., W_{f}), which corresponds to a simpler codebook structure (i.e., it is a special case of Mode 1 for collocated TRPs). For example, in Mode 2, the codebook to provide joint or common frequency domain basis selection across N TRPs or TRP groups may be given by

$$W = [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] .$$

To handle an increasing complexity of uplink control information (UCI) complexity and/or to reduce signaling overhead for Type II codebook using multi-TRP (mTRP), embodiments disclosed herein provide for dividing and assembling UCI into different segments or parts. In addition, or in other embodiments, UCI omission procedures are provided.

### UCI Assembly

In certain embodiments, CSI feedback (i.e., UCI) of Type II codebook refinement for mTRP CJT may include general components, spatial basis (i.e., W₁) components, frequency basis (i.e., W_{f}) components, and linear combination coefficient (i.e., W₂) components. The general components may include, for example, rank indicator (RI), a wideband channel quality indicator (CQI), a subband CQI, and/or a dynamic TRP selection bitmap.

The spatial basis (i.e., W₁) components may include, for example, a dynamic selection of a list of the number of spatial basis selected for each TRP. For regular Type II CSI for mTRP CJT, the spatial basis components may include a rotation factor and a spatial basis indicator. For Type II port selection (PS) CSI for mTRP CJT, the spatial basis components may include a port indicator.

The frequency basis (i.e., W_{f}) components may include, for example, a frequency basis indicator.

The linear combination coefficient (i.e., W₂) components may include, for example, a total number of non-zero (NZ) coefficients, a strongest coefficient indicator (SCI), a bitmap of the NZ coefficient locations, a phase quantization of the NZ coefficients, and/or an amplitude quantization of the NZ coefficients.

In certain embodiments, Type II CSI comprises a first CSI part (CSI part 1) that has a fixed or predetermined payload size and a second CSI part (CSI part 2) that has a flexible payload size. Thus, for example, a base station may first decode CSI part 1 to determine the payload size of CSI part 2. The CSI part 2 may be further divided into CSI part 2 Group 0, CSI part 2 Group 1, and CSI part 2 Group 2. In terms of priority for transmitting CSI from the UE to a base station, CSI part 1 has a higher priority than CSI part 2 Group 0, CSI part 2 Group 0 has a higher priority than CSI part 2 Group 1, and CSI part 2 Group 1 has a higher priority than CSI part 2 Group 2.

In certain embodiments, for Type II codebook for mTRP CJT, the UE is configured to generate the CSI part 1 with general components RI, wideband CQI, subband CQI, and dynamic TRP selection bitmap, and with the spatial basis (i.e., W₁) component corresponding to the dynamic selection of the list of the number of spatial basis selected for each TRP. The base station uses the dynamic TRP selection bitmap and the number of spatial basis selections for each TRP to determine the payload size of the CSI part 2. Thus, the UE includes this information in the CSI part 1.

In addition, or in other embodiments for Type II codebook for mTRP CJT, the UE is configured to generate the CSI part 2 Group 0 with spatial basis (i.e., W₁) components having sizes that are dynamic and depend on the information provided in the CSI part 1. For example, for regular Type II CSI the CSI part 2 Group 0 includes the rotation factor and the spatial basis indicator, and for Type II PS CSI the CSI part 2 Group 0 includes the port indicator.

In addition, or in other embodiments for Type II codebook for mTRP CJT, the UE is configured to include the frequency basis indicator of the frequency basis (i.e., W_{f}) components in either the CSI part 2 Group 0 or the CSI part 2 Group 1. In one such embodiment, the UE is configured to select between the different groups based on different enhanced Type II CSI. For example, the UE may include the frequency basis indicator in the CSI part 2 Group 0 when configured for enhanced Rel-17 Type II port selection CSI for mTRP CJT, and the UE may include the frequency basis indicator in the CSI part 2 Group 1 when configured for enhanced Rel-16 Type II CSI for mTRP CJT.

In addition, or in other embodiments for Type II codebook for mTRP CJT, the UE is configured to generate the CSI part 1 to further include the total number of NZ coefficients of the linear combination coefficient (i.e., W₂) components. As the reported total number of NZ coefficients impacts the size of CSI part 2, the base station may use the total number of NZ coefficients, if included in the CSI part 1, to further determine the size of the CSI part 2.

In addition, or in other embodiments for Type II codebook for mTRP CJT, the UE is configured to generate the CSI part 2 Group 0 with the SCI. The SCI has a highest priority of the linear combination coefficient (i.e., W₂) components. Thus, the SCI may be included in the group of CSI part 2 with the highest priority, i.e., Group 0.

In addition, or in other embodiments for Type II codebook for mTRP CJT, the UE is configured to divide the following linear combination coefficient (i.e., W₂) components into a first group and a second group: the bitmap of the NZ coefficient locations, the phase quantization of the NZ coefficients, and the amplitude quantization of the NZ coefficients. The first group and the second group may be approximately the same size, for example for phase quantization of the NZ coefficients, and the amplitude quantization of the NZ coefficients. The first group and the second group may be different sizes, for example for the bitmap of the NZ coefficient locations. These linear combination coefficient (i.e., W₂) components may comprise the largest amount of CSI feedback overhead. Further, the base station may be able to at least partially approximate the channel conditions with only part or none of these components. Thus, to reduce overhead, the first group and the second group may be given relatively lower priorities. For example, in one embodiment, the UE reports the first group in the CSI part 2 Group 1 and the second group in the CSI part 2 Group 2.

When the phase quantization of the NZ coefficients and the amplitude quantization of the NZ coefficients are divided into two groups, according to one embodiment, the UE and/or the base station may determine the size of the first group by max(0, ┌K^{NZ}/2┐−v) and the size of the second group by min(K^{NZ}−v, └K^{NZ}/2┘), where v is a number of layers in the CSI report information and K^{NZ} is a reported total number of NZ coefficients in the combination coefficient matrix W₂. When the phase quantization of the NZ coefficients and the amplitude quantization of the NZ coefficients are divided into two groups, according to another embodiment, the UE and/or the base station may determine the size of the first group by ┌(K^{NZ}−v)/2┐ and the size of the second group by └(K^{NZ}−v)/2┘.

When the bitmap of the NZ coefficient locations is divided into two groups, according to one embodiment, the UE and/or the base station may determine the size of the first group by K−min(K^{NZ}−v, └K^{NZ}/2┘) and the size of the second group by min(K^{NZ}−v, └K^{NZ}/2┘), where K is a total number of coefficients in the combination coefficient matrix W₂. When the bitmap of the NZ coefficient locations is divided into two groups, according to another embodiment, the UE and/or the base station may determine the size of the first group by K−└(K^{NZ}−v)/2┘ and the size of the second group by └(K^{NZ}−v)/2┘. When the bitmap of the NZ coefficient locations is divided into two groups, according to yet another embodiment, the UE and/or the base station may determine the size of the first group by K−└K^{NZ}/2┘ and the size of the second group by └K^{NZ}/2┘. In certain embodiments, a design principle is that the first group size=K−the size of the second group for amplitude/phase quantization of the NZ coefficient, and the second group size may be the size of the second group for amplitude/phase quantization of the NZ coefficient.

### UCI Omission

In certain wireless systems, there may be large differences in payload sizes for different selections (e.g., RI) by the UE for Type II CSI reporting. Due to these differences, the uplink resource allocation for carrying the CSI report may not fit the entire UCI payload. Further, the base station may not entirely predict the payload size before scheduling the CSI report, which may result in the resource allocation being too small. Thus, certain embodiments herein include dividing the UCI payload into different priority levels and omitting UCI starting with the lowest priority level.

In certain embodiments for Type II codebook for mTRP CJT, for UCI omission, the UE is configured to divide the following linear combination coefficient (i.e., W₂) components into a first group and a second group: the bitmap of the NZ coefficient locations, the phase quantization of the NZ coefficients, and the amplitude quantization of the NZ coefficients. As discussed above, these linear combination coefficient (i.e., W₂) components may comprise the largest amount of CSI feedback overhead. Further, the base station may be able to at least partially approximate the channel conditions with only part or none of these components. Thus, to reduce overhead, the first group and the second group may be given relatively lower priorities. For example, in one embodiment, the UE reports the first group in the CSI part 2 Group 1 and the second group in the CSI part 2 Group 2.

In certain such embodiments, the linear combination coefficients in the combination coefficient matrix W₂ have associated priorities. The linear combination coefficients in the combination coefficient matrix W₂ with higher priorities are reported in CSI part 2 Group 1 and the linear combination coefficients in the combination coefficient matrix W₂ with lower priorities are reported in CSI part 2 Group 2.

In one embodiment for Type II codebook for mTRP CJT, for UCI omission, the UE and/or the base station is configured to compute the priority of each linear combination coefficient in the combination coefficient matrix W₂ based on a priority function Pri(l, i, f)=2L·v·f+v·i+l, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index.

In one embodiment for Type II codebook for mTRP CJT, for UCI omission, the UE and/or the base station is configured to compute the priority of each linear combination coefficient in the combination coefficient matrix W₂ based on a priority function Pri(l, i, f)=2L·v·π(f)+vπi+l, wherein a smaller value of the priority function Pri(l, i, f) has a higher priority, wherein L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index. A function

$$π ( f ) = min ( 2 \cdot {n}_{3 , l}^{( f )} , 2 \cdot ( {N}_{3} - {n}_{3 , l}^{( f )} ) - 1 )$$

prioritizes the frequency basis index f in an order 0, N₃−1, 1, N₃−2, 2, . . . , where N₃ is a number of subbands and

$${n}_{3 , l}^{( f )} = 0 , 1 , … , {N}_{3} - 1$$

is an index for an f^{th} selected frequency basis for a layer corresponding to the layer index l.

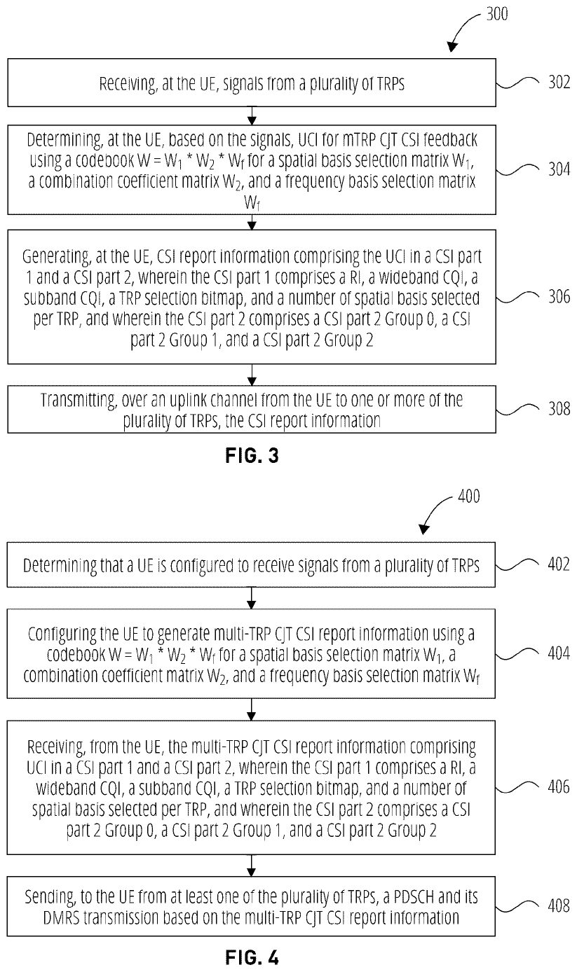

FIG. 3 illustrates a flowchart of a method 300 of a UE for communication in a wireless network, according to embodiments herein. The method 300 includes receiving 302, at the UE, signals from a plurality of TRPs. The method 300 further includes determining 304, at the UE, based on the signals, UCI for mTRP CJT CSI feedback using a codebook W=W₁*W₂*W_{f} for a spatial basis selection matrix W₁, a combination coefficient matrix W₂, and a frequency basis selection matrix W_{f}. The method 300 further includes generating 306, at the UE, CSI report information comprising the UCI in a first CSI part (CSI part 1) and a second CSI part (CSI part 2). The CSI part 1 comprises a RI, a wideband CQI, a subband CQI, a TRP selection bitmap, and a number of spatial basis selected per TRP. The CSI part 2 comprises a CSI part 2 Group 0, a CSI part 2 Group 1, and a CSI part 2 Group 2. The method 300 further includes transmitting 308, over an uplink channel from the UE to one or more of the plurality of TRPs, the CSI report information.

In some embodiments of the method 300, for Type II CSI for mTRP CJT, the CSI part 2 Group 0 comprises a rotation factor and a spatial basis indicator for the spatial basis selection matrix W₁.

In some embodiments of the method 300, for Type II port selection CSI for mTRP CJT, the CSI part 2 Group 0 comprises a port indicator for the spatial basis selection matrix W₁.

In some embodiments of the method 300, the CSI part 2 Group 0 or the CSI part 2 Group 1 comprises a frequency basis indicator for the frequency basis selection matrix W_{f}. Some such embodiments further comprise, for Type II port selection CSI for mTRP CJT selecting the CSI part 2 Group 0 for the frequency basis indicator, and for Type II CSI for mTRP CJT selecting the CSI part 2 Group 1 for the frequency basis indicator.

In some embodiments of the method 300, the CSI part 1 further comprises a total number of NZ coefficients for the combination coefficient matrix W₂.

In some embodiments of the method 300, the CSI part 2 Group 0 comprises a strongest coefficient indicator for the combination coefficient matrix W₂.

In some embodiments, the method 300 further comprises: dividing linear combination coefficient information into a first group and a second group, wherein the linear combination coefficient information comprises one or more of a bitmap of NZ coefficient locations, a phase quantization of an NZ coefficient, and an amplitude quantization of the NZ coefficient, reporting the first group in the CSI part 2 Group 1, and reporting the second group in the CSI part 2 Group 2.

In some such embodiments, when the linear combination coefficient information comprises the phase quantization of the NZ coefficient and the amplitude quantization of the NZ coefficient divided into the first group and the second group: a first size of the first group is given by max (0, ┌K^{NZ}/2┐−v), and a second size of the second group is given by min(K^{NZ}−v, └K^{NZ}/2┘), where v is a number of layers in the CSI report information and K^{NZ} is a reported total number of NZ coefficients in the combination coefficient matrix W₂.

In some such embodiments, when the linear combination coefficient information comprises the phase quantization of the NZ coefficient and the amplitude quantization of the NZ coefficient divided into the first group and the second group: a first size of the first group is given by ┌(K^{NZ}−v)/2┐, and a second size of the second group is given by ┌(K^{NZ}−v)/2┐, where v is a number of layers in the CSI report information and K^{NZ} is a reported total number of NZ coefficients in the combination coefficient matrix W₂.

In some embodiments, when the linear combination coefficient information comprises the bitmap of the NZ coefficient locations divided into the first group and the second group: a first size of the first group is given by K−min(K^{NZ}−v, └K^{NZ}/2┘), and a second size of the second group is given by min(K^{NZ}−v, K^{NZ}/2┘), where v is a number of layers in the CSI report information, K is a total number of coefficients in the combination coefficient matrix W₂, and K^{NZ} is a reported total number of NZ coefficients in the combination coefficient matrix W₂.

In some such embodiments, when the linear combination coefficient information comprises the bitmap of the NZ coefficient locations divided into the first group and the second group: a first size of the first group is given by K−└(K^{NZ}−v)/2┘, and a second size of the second group is given by └(K^{NZ}−v)/2┘, where v is a number of layers in the CSI report information, K is a total number of coefficients in the combination coefficient matrix W₂, and K^{NZ} is a reported total number of NZ coefficients in the combination coefficient matrix W₂.

In some such embodiments, when the linear combination coefficient information comprises the bitmap of the NZ coefficient locations divided into the first group and the second group: a first size of the first group is given by K−└K^{NZ}/2┘, and a second size of the second group is given by └K^{NZ}/2┘, where v is a number of layers in the CSI report information, K is a total number of coefficients in the combination coefficient matrix W₂, and K^{NZ} is a reported total number of NZ coefficients in the combination coefficient matrix W₂.

Embodiments contemplated herein include an apparatus comprising means to perform one or more elements of the method 300. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 300. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 802 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 804 of a wireless device 802 that is a UE, as described herein). These instructions may be, for example, located in the processor and/or on a memory

FIG. 4 illustrates a flowchart of a method 400 of a wireless network, according to embodiments herein. The method 400 includes determining 402 that a UE is configured to receive signals from a plurality of TRPs. The method 400 further includes configuring 404 the UE to generate multi-TRP CJT CSI report information using a codebook W=W₁*W₂*W_{f} for a spatial basis selection matrix W₁, a combination coefficient matrix W₂, and a frequency basis selection matrix W_{f}. The method 400 further includes receiving 406, from the UE, the multi-TRP CJT CSI report information comprising UCI in a first CSI part (CSI part 1) and a second CSI part (CSI part 2). The CSI part 1 comprises a RI, a wideband CQI, a subband CQI, a TRP selection bitmap, and a number of spatial basis selected per TRP. The CSI part 2 comprises a CSI part 2 Group 0, a CSI part 2 Group 1, and a CSI part 2 Group 2. The method 400 further includes sending 408, to the UE from at least one of the plurality of TRPs, a physical downlink shared channel (PDSCH) and its demodulation reference signal (DMRS) transmission based on the multi-TRP CJT CSI report information.

In some embodiments of the method 400, for Type II CSI for mTRP CJT, the CSI part 2 Group 0 comprises a rotation factor and a spatial basis indicator for the spatial basis selection matrix W₁.

In some embodiments of the method 400, for Type II port selection CSI for mTRP CJT, the CSI part 2 Group 0 comprises a port indicator for the spatial basis selection matrix W₁.

In some embodiments of the method 400, the CSI part 2 Group 0 or the CSI part 2 Group 1 comprises a frequency basis indicator for the frequency basis selection matrix W_{f}. In some such embodiments, for Type II port selection CSI for mTRP CJT the CSI part 2 Group 0 comprises the frequency basis indicator, and for Type II CSI for mTRP CJT the CSI part 2 Group 1 comprises the frequency basis indicator.

In some embodiments of the method 400, the CSI part 1 further comprises a total number of NZ coefficients for the combination coefficient matrix W₂.

In some embodiments of the method 400, the CSI part 2 Group 0 comprises a strongest coefficient indicator for the combination coefficient matrix W₂.

In some embodiments of the method 400: linear combination coefficient information is divided into a first group and a second group; the linear combination coefficient information comprises one or more of a bitmap of NZ coefficient locations, a phase quantization of an NZ coefficient, and an amplitude quantization of the NZ coefficient; the CSI part 2 Group 1 comprises the first group; and the CSI part 2 Group 2 comprises the second group.

In some such embodiments, when the linear combination coefficient information comprises the phase quantization of the NZ coefficient and the amplitude quantization of the NZ coefficient divided into the first group and the second group: a first size of the first group is given by max (0, ┌K^{NZ}/2┌−v), and a second size of the second group is given by min(K^{NZ}−v, └K^{NZ}/2┘), where v is a number of layers in the CSI report information and K^{NZ} is a reported total number of NZ coefficients in the combination coefficient matrix W₂.

In some such embodiments, when the linear combination coefficient information comprises the phase quantization of the NZ coefficient and the amplitude quantization of the NZ coefficient divided into the first group and the second group: a first size of the first group is given by ┌(K^{NZ}−v)/2┐, and a second size of the second group is given by └(K^{NZ}−v)/2┘, where v is a number of layers in the CSI report information and K^{NZ} is a reported total number of NZ coefficients in the combination coefficient matrix W₂.

In some such embodiments, when the linear combination coefficient information comprises the bitmap of the NZ coefficient locations divided into the first group and the second group: a first size of the first group is given by K−min(K^{NZ}−v, └K^{NZ}/2┘); and a second size of the second group is given by min(K^{NZ}−v, └K^{NZ}/2┘), where v is a number of layers in the CSI report information, K is a total number of coefficients in the combination coefficient matrix W₂, and K^{NZ} is a reported total number of NZ coefficients in the combination coefficient matrix W₂.

In some such embodiments, when the linear combination coefficient information comprises the bitmap of the NZ coefficient locations divided into the first group and the second group: a first size of the first group is given by K−└(K^{NZ}−v)/2┘, and a second size of the second group is given by └(K^{NZ}−v)/2┘, where v is a number of layers in the CSI report information, K is a total number of coefficients in the combination coefficient matrix W₂, and K^{NZ} is a reported total number of NZ coefficients in the combination coefficient matrix W₂.

In some such embodiments, when the linear combination coefficient information comprises the bitmap of the NZ coefficient locations divided into the first group and the second group: a first size of the first group is given by K−└K^{NZ}/2┘; and a second size of the second group is given by └K^{NZ}/2┘, where v is a number of layers in the CSI report information, K is a total number of coefficients in the combination coefficient matrix W₂, and K^{NZ} is a reported total number of NZ coefficients in the combination coefficient matrix W₂.

Embodiments contemplated herein include an apparatus comprising means to perform one or more elements of the method 400. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 400. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a base station (such as a network device 818 that is a base station, as described herein).

Embodiments contemplated herein include a signal as described in or related to one or more elements of the method 400.

Embodiments contemplated herein include a computer program or computer program product comprising instructions, wherein execution of the program by a processing element is to cause the processing element to carry out one or more elements of the method 400. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

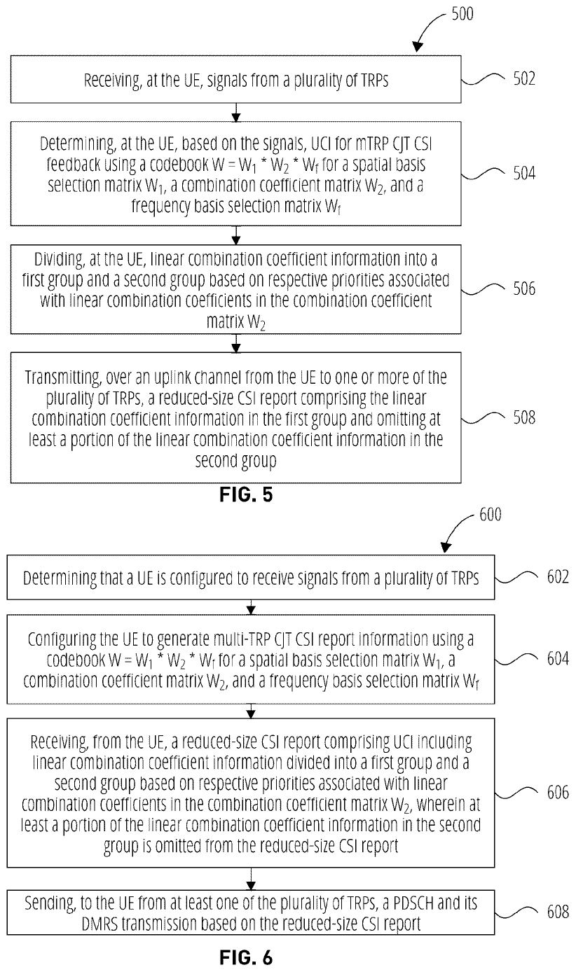

FIG. 5 illustrates a flowchart of a method 500 of a UE for communication in a wireless network, according to embodiments herein. The method 500 includes receiving 502, at the UE, signals from a plurality of TRPs. The method 500 further includes determining 504, at the UE, based on the signals, UCI for mTRP CJT CSI feedback using a codebook W=W₁*W₂*W_{f} for a spatial basis selection matrix W₁, a combination coefficient matrix W₂, and a frequency basis selection matrix W_{f}. The method 500 further includes dividing 506, at the UE, linear combination coefficient information into a first group and a second group based on respective priorities associated with linear combination coefficients in the combination coefficient matrix W₂. The method 500 further includes transmitting 508, over an uplink channel from the UE to one or more of the plurality of TRPs, a reduced-size CSI report comprising the linear combination coefficient information in the first group and omitting at least a portion of the linear combination coefficient information in the second group.

In some embodiments, the method 500 further comprises: generating, at the UE, CSI report information comprising the UCI in a first CSI part (CSI part 1) and a second CSI part (CSI part 2), wherein the CSI part 2 comprises a CSI part 2 Group 0, a CSI part 2 Group 1, and a CSI part 2 Group 2; reporting the first group in the CSI part 2 Group 1; and reporting the second group in the CSI part 2 Group 2, wherein the respective priorities associated with the linear combination coefficients for the first group are higher than the respective priorities associated with the linear combination coefficients for the second group. In some such embodiments, transmitting the reduced-size CSI report comprises transmitting the CSI part 2 Group 1 and dropping the CSI part 2 Group 2.

In some embodiments of the method 500, the linear combination coefficient information comprises one or more of a bitmap of NZ coefficient locations, a phase quantization of an NZ coefficient, and an amplitude quantization of the NZ coefficient.

In some embodiments, the method 500 further comprises computing, at the UE, the respective priorities associated with the linear combination coefficients in the combination coefficient matrix W₂. In some such embodiments, the respective priorities are based on a priority function Pri(l, i, f)=2L·v·f+v·i+1, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index. In other embodiments, the respective priorities are based on a priority function Pri(l, i, f)=2L·v·π(f)+v·i+l, wherein a smaller value of the priority function Pri(l, i, f) has a higher priority, wherein L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index, and wherein function

$$π ( f ) = min ( 2 \cdot {n}_{3 , l}^{( f )} , 2 \cdot ( {N}_{3} - {n}_{3 , l}^{( f )} ) - 1 )$$

prioritizes the frequency basis index f in an order 0, N₃−1, 1, N₃−2, 2, . . . , where N₃ is a number of subbands and

$${n}_{3 , l}^{( f )} = 0 , 1 , … , {N}_{3} - 1$$

an index for an f^{th} selected frequency basis for a layer corresponding to the layer index l.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory

FIG. 6 illustrates a flowchart of a method 600 of a wireless network, according to embodiments herein. The method 600 includes determining 602 that a UE is configured to receive signals from a plurality of TRPs. The method 600 further includes configuring 604 the UE to generate multi-TRP CJT CSI report information using a codebook W=W₁*W₂*W_{f} for a spatial basis selection matrix W₁, a combination coefficient matrix W₂, and a frequency basis selection matrix W_{f}. The method 600 further includes receiving 606, from the UE, a reduced-size CSI report comprising UCI including linear combination coefficient information divided into a first group and a second group based on respective priorities associated with linear combination coefficients in the combination coefficient matrix W₂, wherein at least a portion of the linear combination coefficient information in the second group is omitted from the reduced-size CSI report. The method 600 further includes sending 608, to the UE from at least one of the plurality of TRPs, a PDSCH and its DMRS transmission based on the reduced-size CSI report.

In some embodiments of the method 600, the reduced-size CSI report includes the UCI in a first CSI part (CSI part 1) and a second CSI part (CSI part 2), wherein the CSI part 2 comprises a CSI part 2 Group 0, a CSI part 2 Group 1, and a CSI part 2 Group 2. The CSI part 2 Group 1 comprises the first group. The CSI part 2 Group 2 comprises the second group. The respective priorities associated with the linear combination coefficients for the first group are higher than the respective priorities associated with the linear combination coefficients for the second group. In some such embodiments, the reduced-size CSI report comprises the CSI part 2 Group 1, and the CSI part 2 Group 2 is dropped from the reduced-size CSI report.

In some embodiments of the method 600, the linear combination coefficient information comprises one or more of a bitmap of NZ coefficient locations, a phase quantization of an NZ coefficient, and an amplitude quantization of the NZ coefficient.

In some embodiments, the method 600 further comprises computing the respective priorities associated with the linear combination coefficients in the combination coefficient matrix W₂. In some such embodiments, the respective priorities are based on a priority function Pri(l, i, f)=2L·v·f+v·i+l, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index.

In other embodiments, the respective priorities are based on a priority function Pri(l, i, f)=2L·v·π(f)+v·i+l, wherein a smaller value of the priority function Pri(l, i, f) has a higher priority, wherein L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index. The function

$$π ( f ) = min ( 2 \cdot {n}_{3 , l}^{( f )} , 2 \cdot ( {N}_{3} - {n}_{3 , l}^{( f )} ) - 1 )$$

prioritizes the frequency basis index fin an order 0, N₃−1, 1, N₃−2, 2, . . . , where N₃ is a number of subbands and

$${n}_{3 , l}^{( f )} = 0 , 1 , … , {N}_{3} - 1$$

is an index for an f^{th} selected frequency basis for a layer corresponding to the layer index l.

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

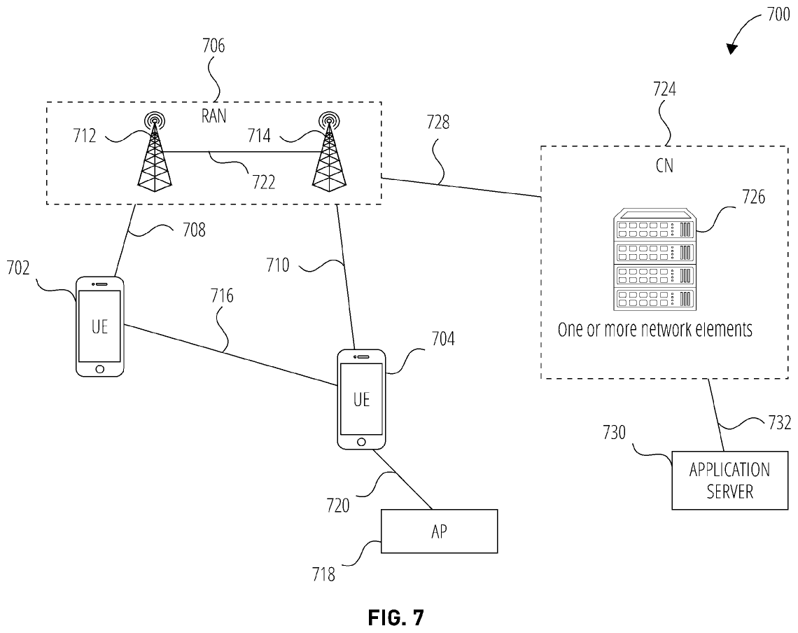

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VOIP sessions, group communication sessions, etc.) for the UE 702 and UE 704 via the CN 724. The application server 730 may communicate with the CN 724 through an IP communications interface 732.

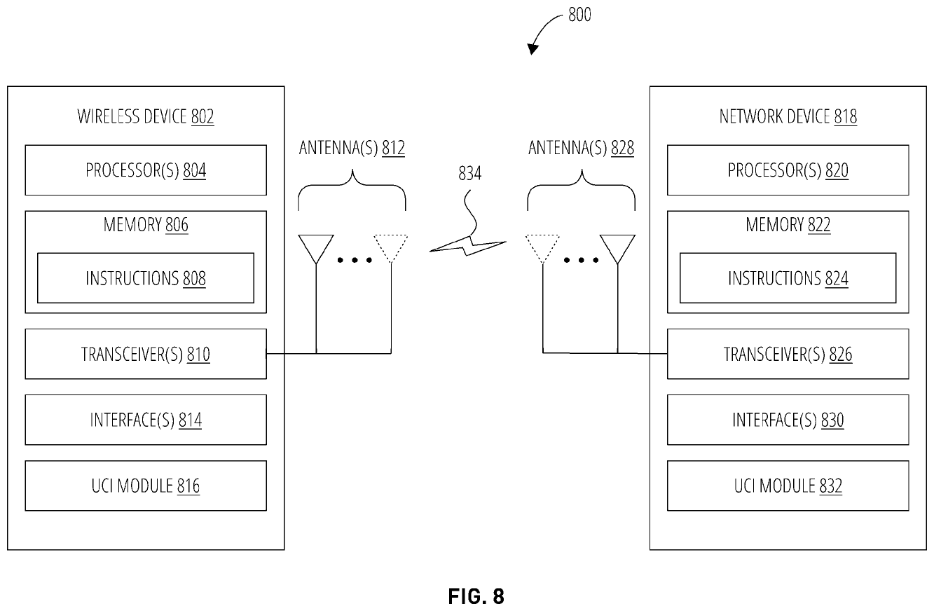

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a UCI module 816. The UCI module 816 may be implemented via hardware, software, or combinations thereof. For example, the UCI module 816 may be implemented as a processor, circuit, and/or instructions 808 stored in the memory 806 and executed by the processor(s) 804. In some examples, the UCI module 816 may be integrated within the processor(s) 804 and/or the transceiver(s) 810. For example, the UCI module 816 may be implemented by a combination of software components (e.g., executed by a DSP or a general processor) and hardware components (e.g., logic gates and circuitry) within the processor(s) 804 or the transceiver(s) 810.

The UCI module 816 may be used for various aspects of the present disclosure, for example, aspects of FIG. 1, FIG. 2, FIG. 3, and FIG. 5. The UCI module 816 is configured to provide details for Type II codebook refinement for Multi-TRP Coherent Joint Transmission.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a UCI module 832. The UCI module 832 may be implemented via hardware, software, or combinations thereof. For example, the UCI module 832 may be implemented as a processor, circuit, and/or instructions 824 stored in the memory 822 and executed by the processor(s) 820. In some examples, the UCI module 832 may be integrated within the processor(s) 820 and/or the transceiver(s) 826. For example, the UCI module 832 may be implemented by a combination of software components (e.g., executed by a DSP or a general processor) and hardware components (e.g., logic gates and circuitry) within the processor(s) 820 or the transceiver(s) 826.

The UCI module 832 may be used for various aspects of the present disclosure, for example, aspects of FIG. 1, FIG. 2, FIG. 4, and FIG. 6. The UCI module 832 is configured to provide details for Type II codebook refinement for Multi-TRP Coherent Joint Transmission.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for operating a user equipment (UE) for communication in a wireless network, the method comprising:
receiving, at the UE, signals from a plurality of transmission and reception points (TRPs);
determining, at the UE, based on the signals, uplink control information (UCI) for multiple TRP (mTRP) coherent joint transmission (CJT) channel state information (CSI) feedback using a codebook W=W₁*W₂*W_{f} for a spatial basis selection matrix W₁, a combination coefficient matrix W₂, and a frequency basis selection matrix W_{f};
dividing, at the UE, linear combination coefficient information into a first group and a second group based on respective priorities associated with linear combination coefficients in the combination coefficient matrix W₂; and
transmitting, over an uplink channel from the UE to one or more of the plurality of TRPs, a reduced-size CSI report comprising the linear combination coefficient information in the first group and omitting at least a portion of the linear combination coefficient information in the second group.

2. The method of claim 1, further comprising:
generating, at the UE, CSI report information comprising the UCI in a first CSI part (CSI part 1) and a second CSI part (CSI part 2), wherein the CSI part 2 comprises a CSI part 2 Group 0, a CSI part 2 Group 1, and a CSI part 2 Group 2;
reporting the first group in the CSI part 2 Group 1; and
reporting the second group in the CSI part 2 Group 2, wherein the respective priorities associated with the linear combination coefficients for the first group are higher than the respective priorities associated with the linear combination coefficients for the second group.

3. The method of claim 2, wherein transmitting the reduced-size CSI report comprising transmitting the CSI part 2 Group 1 and dropping the CSI part 2 Group 2.

4. The method of claim 1, wherein the linear combination coefficient information comprises one or more of a bitmap of non-zero (NZ) coefficient locations, a phase quantization of an NZ coefficient, and an amplitude quantization of the NZ coefficient.

5. The method of claim 1, further comprising computing, at the UE, the respective priorities associated with the linear combination coefficients in the combination coefficient matrix W₂.

6. The method of claim 5, wherein the respective priorities are based on a priority function Pri(l, i, f)=2L·v·f+v·i+l, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index.

7. The method of claim 5, wherein the respective priorities are based on a priority function Pri(l, i, f)=2L·v·π(f)+v·i+l,
wherein a smaller value of the priority function Pri(l, i, f) has a higher priority,
wherein L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index, and
wherein function
$$π ( f ) = min ( 2 \cdot {n}_{3 , l}^{( f )} , 2 \cdot ( {N}_{3} - {n}_{3 , l}^{( f )} ) - 1 )$$
prioritizes the frequency basis index fin an order 0, N₃−1, 1, N₃−2, 2, . . . , where N₃ is a number of subbands and
$${n}_{3 , l}^{( f )} = 0 , 1 , … , {N}_{3} - 1$$
is an index for an f^{th} selected frequency basis for a layer corresponding to the layer index l.

8. A method for a wireless network, the method comprising:
determining that a user equipment (UE) is configured to receive signals from a plurality of transmission and reception points (TRPs);
configuring the UE to generate multiple TRP (multi-TRP) coherent joint transmission (CJT) channel state information (CSI) report information using a codebook W=W₁*W₂*W_{f} for a spatial basis selection matrix W₁, a combination coefficient matrix W₂, and a frequency basis selection matrix W_{f};
receiving, from the UE, a reduced-size CSI report comprising uplink control information (UCI) including linear combination coefficient information divided into a first group and a second group based on respective priorities associated with linear combination coefficients in the combination coefficient matrix W₂, wherein at least a portion of the linear combination coefficient information in the second group is omitted from the reduced-size CSI report; and
sending, to the UE from at least one of the plurality of TRPs, a physical downlink shared channel (PDSCH) and its demodulation reference signal (DMRS) transmission based on the reduced-size CSI report.

9. The method of claim 8, wherein:
the reduced-size CSI report includes the UCI in a first CSI part (CSI part 1) and a second CSI part (CSI part 2), wherein the CSI part 2 comprises a CSI part 2 Group 0, a CSI part 2 Group 1, and a CSI part 2 Group 2;
the CSI part 2 Group 1 comprises the first group; and
the CSI part 2 Group 2 comprises the second group, wherein the respective priorities associated with the linear combination coefficients for the first group are higher than the respective priorities associated with the linear combination coefficients for the second group.

10. The method of claim 9, wherein the reduced-size CSI report comprises the CSI part 2 Group 1, and wherein the CSI part 2 Group 2 is dropped from the reduced-size CSI report.

11. The method of claim 8, wherein the linear combination coefficient information comprises one or more of a bitmap of non-zero (NZ) coefficient locations, a phase quantization of an NZ coefficient, and an amplitude quantization of the NZ coefficient.

12. The method of claim 8, further comprising computing the respective priorities associated with the linear combination coefficients in the combination coefficient matrix W₂.

13. The method of claim 12, wherein the respective priorities are based on a priority function Pri(l, i, f)=2L·v·f+v·i+l, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index.

14. The method of claim 12, wherein the respective priorities are based on a priority function Pri(l, i, f)=2L·v·π(f)+v·i+l,
wherein a smaller value of the priority function Pri(l, i, f) has a higher priority,
wherein L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index, and
wherein function
$$π ( f ) = min ( 2 \cdot {n}_{3 , l}^{( f )} , 2 \cdot ( {N}_{3} - {n}_{3 , l}^{( f )} ) - 1 )$$
prioritizes the frequency basis index fin an order 0, N₃−1, 1, N₃−2, 2, . . . , where N₃ is a number of subbands and
$${n}_{3 , l}^{( f )} = 0 , 1 , … , {N}_{3} - 1$$
is an index for an f^{th} selected frequency basis for a layer corresponding to the layer index l.

15. A user equipment (UE), comprising:
a transceiver to receive signals from a plurality of transmission and reception points (TRPs); and
one or more processors to:
determine, based on the signals, uplink control information (UCI) for multiple TRP (mTRP) coherent joint transmission (CJT) channel state information (CSI) feedback using a codebook W=W₁*W₂*W_{f} for a spatial basis selection matrix W₁, a combination coefficient matrix W₂, and a frequency basis selection matrix W_{f};
divide linear combination coefficient information into a first group and a second group based on respective priorities associated with linear combination coefficients in the combination coefficient matrix W₂; and
instruct the transceiver to transmit, over an uplink channel from the UE to one or more of the plurality of TRPs, a reduced-size CSI report comprising the linear combination coefficient information in the first group and omitting at least a portion of the linear combination coefficient information in the second group.

16. The UE of claim 15, further comprising:
generating, at the UE, CSI report information comprising the UCI in a first CSI part (CSI part 1) and a second CSI part (CSI part 2), wherein the CSI part 2 comprises a CSI part 2 Group 0, a CSI part 2 Group 1, and a CSI part 2 Group 2;
reporting the first group in the CSI part 2 Group 1; and
reporting the second group in the CSI part 2 Group 2, wherein the respective priorities associated with the linear combination coefficients for the first group are higher than the respective priorities associated with the linear combination coefficients for the second group.

17. The UE of claim 16, wherein transmitting the reduced-size CSI report comprising transmitting the CSI part 2 Group 1 and dropping the CSI part 2 Group 2.

18. The UE of claim 15, wherein the linear combination coefficient information comprises one or more of a bitmap of non-zero (NZ) coefficient locations, a phase quantization of an NZ coefficient, and an amplitude quantization of the NZ coefficient.

19. The UE of claim 15, further comprising computing, at the UE, the respective priorities associated with the linear combination coefficients in the combination coefficient matrix W₂.

20. The UE of claim 19, wherein the respective priorities are based on a priority function Pri(l, i, f)=2L·v·f+v·i+l, wherein a smaller value of the priority function Pri(l, i, f) has a higher priority, and where L is a number of selected spatial basis per polarization, v is a number of layers in the CSI report, M is a number of selected frequency basis, l=0, . . . , v−1 is a layer index, i=0, . . . , 2L−1 is a spatial basis index or port index, and f=0, . . . , M−1 is a frequency basis index.

21-24. (canceled)
